(19) United States
(12) Patent Application Publication
(10) Pub. No.: US 2020/0387192 A1
(43) Pub. Date: Dec. 10, 2020

(54) WEARABLE PET IDENTIFICATION TAG FOR PET OWNERS TO NOTIFY THEIR CAREGIVERS, IN THE EVENT OF AN EMERGENCY, THAT THE WEARER HAS PETS IN NEED OF CARE

(71) Applicant: Janice Cori-Cobb, Hamburg, NJ (US)

(72) Inventor: Janice Cori-Cobb, Hamburg, NJ (US)

(21) Appl. No.: 16/587,958

(22) Filed: Sep. 30, 2019

Related U.S. Application Data
(60) Provisional application No. 62/856,841, filed on Jun. 4, 2019.

(51) Int. Cl. G06F 1/16; A01K 27/00; A01K 11/00

(52) U.S. Cl. CPC G06F 1/163; A01K 11/006; A01K 27/001

(57) ABSTRACT

A wearable pet identification tag is provided. The wearable pet identification tag is for pet owners to notify their caregivers, in the event of an emergency, that the wearer has pets in need of care, and how to care for the pets, in case the pet owner no longer can. The wearable pet identification tag may include a surface for providing location-based, identification-based and care-based information associated with one or more pet owned by the wearer. The wearable pet identification tag is removably worn by the pet owner so that future caregivers can themselves utilize the present invention.

### CROSS-REFERENCE TO RELATED APPLICATION

This application claims the benefit of priority of U.S. provisional application No. 62/856,841 filed 4 Jun. 2019, the contents of which are herein incorporated by reference.

### BACKGROUND OF THE INVENTION

The present invention relates to pet care devices and, more particularly, to a wearable pet identification tag for pet owners to notify their caregivers, in the event of an emergency, that the wearer has pets in need of care.

Animal pets play an important role in many people's lives. In fact, there is ample research finding that having a pet enhances both the physical, as well as the emotional wellbeing of the pet owner. As a result, there are innumerable pets owned by people living alone for these reasons. Among these pet owners living alone, many are elderly or have medical conditions that make them more prone to the being isolated, relative to the general population. As a corollary, the pets of such pet owners are also vulnerable in that if adverse circumstances strike their pet owner, there is nobody else to even notify others that their pet is in need of care.

The inventor thought of having pet owners carry cards in their wallets and handbags for purposes of alerting those who may come upon such a pet owner in need of emergency medical treatment, or worse, so as to convey vital information about the pet owner's pet; however, in addition to being easily destroyed, such cards could be too often either misplaced or overlooked, rendering them ineffective for this intended application.

As can be seen, there is a need for a wearable pet identification tag for pet owners to notify their caregivers, in the event of an emergency, that the wearer has pets in need of care, and how to care for the pets. The present invention embodies a wearable pet identification tag to be worn on the person of the pet owner so that if adverse circumstances were to befall them, such as illness, accident or death, notification of an associated vulnerable pet animal would be readily ascertained by the pet owner's caregivers.

The wearable pet identification tag (colloquially known as “Save My Pet ID Tag”) may be manufactured from durable metal, and worn by the pet owner. As a result, the pet identification/notification tag may be easily seen by prospective rescuers, providing knowledge of the otherwise unknown pets as to where they can be found, how they can be befriended as well as specific care-related information for that pet so they too can be identified, found and appropriately cared for in the event that the pet owner was incapable of doing so going forward.

### SUMMARY OF THE INVENTION

In one aspect of the present invention a wearable pet identification tag for an incapacitated pet owner to notify caregivers of one or more pets associated with the incapacitated pet owner includes the following: a body having a printing surface; connector attached to the body so that the body is adapted to be worn by a human being; and a first pet information represented on the printing surface, wherein the pet information consists of a location of one or more pet associated with the human being.

In another aspect of the present invention, the wearable pet identification tag for an incapacitated pet owner to notify caregivers of one or more pets associated with the incapacitated pet owner includes the following: a disc-shaped body having a printing surface; a connector attached to the body a chain connected to the connector so that the body is adapted to be worn by a human being; a first pet information represented on the printing surface, wherein the pet information consists of a location of one or more pet associated with the human being; and a second pet information represented on the printing surface, the second pet information includes the following: information to identify said one or more pet; information regarding a special diet of said one or more pet; and information regarding a dose of medication to be taken by said one or more pet.

These and other features, aspects and advantages of the present invention will become better understood with reference to the following drawings, description and claims.

### BRIEF DESCRIPTION OF THE DRAWINGS

FIG. 1 is a front elevation view of an exemplary embodiment of the present invention;

FIG. 2 is a front elevation view of an exemplary embodiment of the present invention;

FIG. 3 is a perspective view of an exemplary embodiment of the present invention; and

FIG. 4 is a perspective view of an exemplary embodiment of the present invention, shown in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a wearable pet identification tag for pet owners to notify their caregivers, in the event of an emergency, that the wearer has pets in need of care, and how to care for the pets, in case the pet owner no longer can. The wearable pet identification tag may include a surface for providing location-based, identification-based and care-based information associated with one or more pet owned by the wearer. The wearable pet identification tag is removably worn by the pet owner so that future caregivers can themselves utilize the present invention in the short term or the long term.

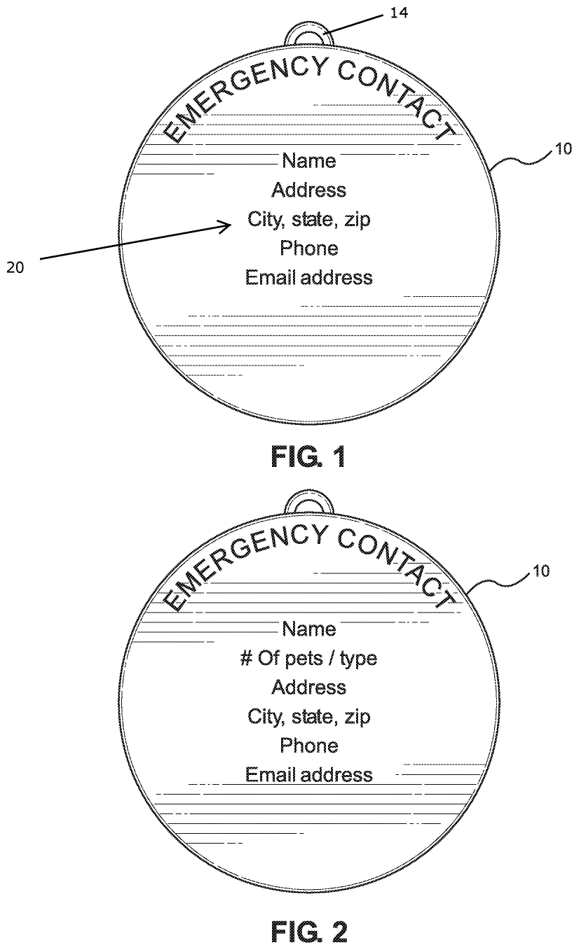

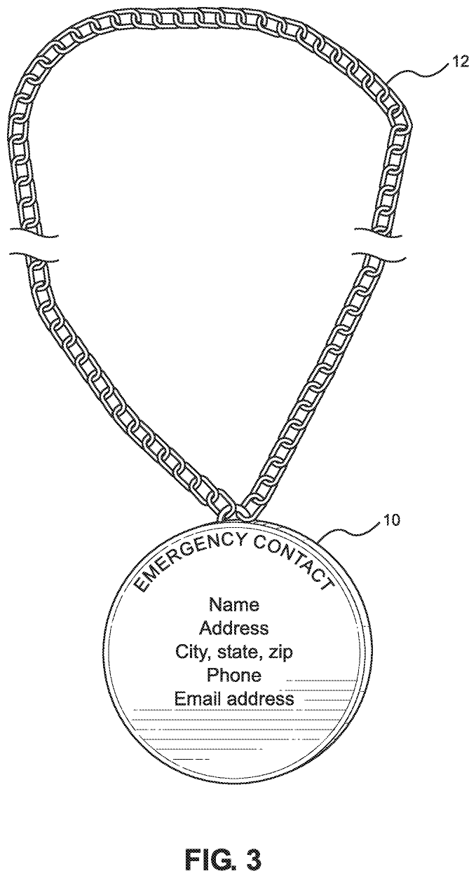

Referring to FIGS. 1 through 4, the present invention may include a pet notification tag 10 that may be worn by a pet owner, for example, through a wearable, removable fastener such as a chain 12. The wearable pet notification tag 10 could be part of a necklace, a wrist bracelet, an ankle bracelet or the like, so that in the event the pet owner were, say, incapacitated, a caregiver could remove the pet notification tag 10 for purposes of utilizing its information to care for the associated pets at a later time and possibly a relatively far distance away.

The wearable pet notification tag 10 may be made from material resilient enough to function as disclosed herein, for example, various plasticized and metallic materials, specifically enabling the representation of informational indicium 20 along one or more surface thereof. The wearable pet notification tag 10, likewise, may take various shapes, e.g. a disk of approximately the size of a quarter, as long as it functions as disclosed herein.

The wearable pet notification tag 10 may provide a chain connector 14, such as a loop, for operatively attaching the chain 12 for enabling the present invention to be removably wearable by the pet owner.

The informational indicium 20 could represent data vital for the location, identification, bonding with, and care of the wearer's pet. The informational indicium 20 may include the name, number and type of pets, where the pets are housed, contact information, such as the address, phone number, email of alternative caregivers for the pets. The informational indicium 20 may also include pet-specific instructions, for example, if the pet requires certain medication or a special diet. Accordingly, even though just one example of the informational indicium 20 is shown in the illustrations, it should be understood that the informational indicium 20 may include, but not be limited to, information relative to the pet(s) care, information relative to a “time trusted” contact, emergency information, (e.g. insulin) relative to the care of pets of the incapacitated pet owner so as to be readily available. The informational indicium 20 may be printed onto the wearable pet notification tag 10 through laser printing or other permanent methods.

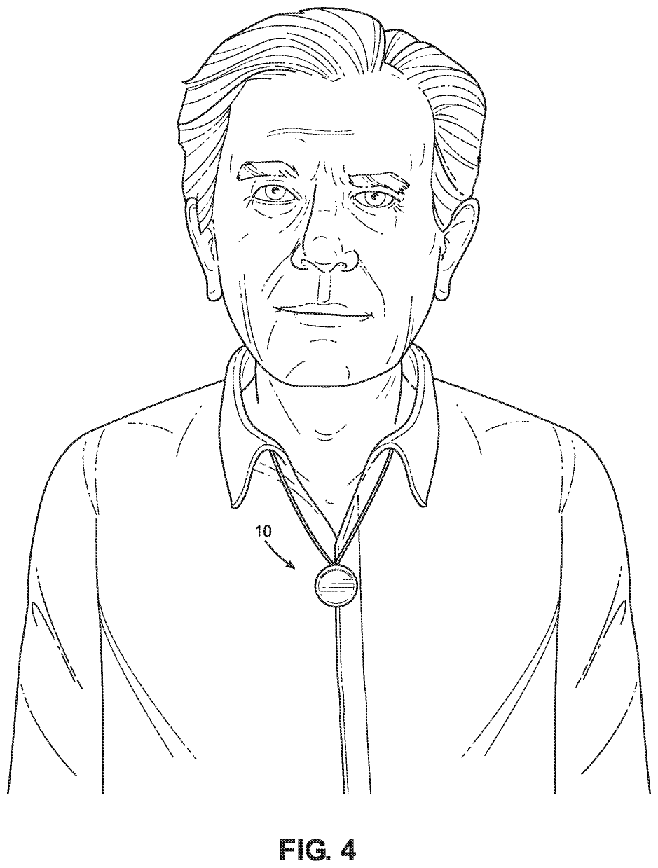

A method of using the present invention may include the following. A pet-owner may wear the pet notification tag 10 on their person, as illustrated in FIG. 4, so that if something were to prevent the wearer from caring for their pets and communicating their pets needs to a substitute caregiver, the wearable pet notification tag 10 would do just that through the informational indicium 20. As a result, knowledge of the otherwise unknown pets would be ascertained by someone coming to the aid of the pet-owner wearer, along with the appropriate care needed for each pet in the event that the pet owner was incapable of doing so going forward.

It should be understood, of course, that the foregoing relates to exemplary embodiments of the invention and that modifications may be made without departing from the spirit and scope of the invention as set forth in the following claims.

What is claimed is:

1. A wearable pet identification tag for an incapacitated pet owner to notify caregivers of one or more pets associated with the incapacitated pet owner, comprising:
a body having a printing surface;
a connector attached to the body so that the body is adapted to be worn by a human being; and
a first pet information represented on the printing surface, wherein the pet information consists of a location of one or more pet associated with the human being.

2. The wearable pet identification tag for an incapacitated pet owner to notify caregivers of one or more pets associated with the incapacitated pet owner of claim 1, further comprising:
a second pet information represented on the printing surface, the second pet information including information to identify said one or more pet.

3. The wearable pet identification tag for an incapacitated pet owner to notify caregivers of one or more pets associated with the incapacitated pet owner of claim 1, wherein the second pet information includes information regarding a special diet of said one or more pet.

4. The wearable pet identification tag for an incapacitated pet owner to notify caregivers of one or more pets associated with the incapacitated pet owner of claim 1, wherein the second pet information includes information regarding a dose of medication to be taken by said one or more pet.

5. The wearable pet identification tag for an incapacitated pet owner to notify caregivers of one or more pets associated with the incapacitated pet owner of claim 1, wherein the body has a disc-like shape.

6. The wearable pet identification tag for an incapacitated pet owner to notify caregivers of one or more pets associated with the incapacitated pet owner of claim 1, further comprising a chain attached to the connector.

7. A wearable pet identification tag for an incapacitated pet owner to notify caregivers of one or more pets associated with the incapacitated pet owner, comprising:
a disc-shaped body having a printing surface;
a connector attached to the body;
a chain connected to the connector so that the body is adapted to be worn by a human being;
a first pet information represented on the printing surface, wherein the pet information consists of a location of one or more pet associated with the human being; and
a second pet information represented on the printing surface, the second pet information comprising:
information to identify said one or more pet;
information regarding a special diet of said one or more pet; and
information regarding a dose of medication to be taken by said one or more pet.

8. A method for an incapacitated pet owner to notify others of one or more pet animals, comprising:
providing the wearable pet identification tag of claim 1; and
donning said wearable pet identification tag when capacitated.

9. The method of claim 8, wherein said wearable pet identification tag is donned by way of a chain attached to the connector.
